(19) United States
(12) Patent Application Publication
(10) Pub. No.: US 2010/0133236 A1
(43) Pub. Date: Jun. 3, 2010

(54) INSTALLATION SWITCHGEAR HAVING A DEVICE FOR MOUNTING THE SAME ON A BUS BAR

(75) Inventor: Joachim Majewski, Dossenheim (DE)

Correspondence Address: Darby & Darby, P.O. Box 770, Church Street Station, New York, NY, 10008-0770, US

(73) Assignee: ABB AG, Mannheim (DE)

(21) Appl. No.: 12/596,130

(22) PCT Filed: Apr. 17, 2008
(86) PCT No.: PCT/EP08/03095

§ 371 Date: Oct. 15, 2009

(30) Foreign Application Priority Data
Apr. 19, 2007 (DE) 10 2007 018 521.0
Apr. 17, 2008 (DE) 10 2008 019 474.3

(51) Int. Cl. H01H 33/08

(52) U.S. Cl. 218/157

(57) ABSTRACT

An installation switching device includes an installation device housing including a housing interior, a connecting terminal disposed on a narrow face of the installation device housing, a switching apparatus including a quenching chamber, a vent channel configured to allow switching gases from a switching operation to escape from the housing interior through an outlet opening disposed close to the connecting terminal, and an attachment element disposed on the narrow face. The attachment element includes an exhaust-gas channel having an inlet opening corresponding with the outlet opening of the vent channel so as to allow the switching gases to pass from the outlet opening of the vent channel through the exhaust-gas channel, the attachment element configured to attach the installation switching device to a busbar.

This is a U.S. National Phase Application under 35 U.S.C. §171 of International Application No. PCT/EP2008/003095, filed on Apr. 17, 2008, which claims priority to German Application No. DE 10 2007 018 521.0, filed on Apr. 19, 2007 and German Application No. DE 10 2008 019 474.3, filed on Apr. 17, 2008. The International Application was published in German on Oct. 30, 2008 as WO 2008/128705 under PCT article 21(2).

The invention relates to an installation switching device, preferably a main line circuit breaker, for installation in the meter station of an installation distribution block.

### BACKGROUND

Installation switching devices of this generic type have an insulating material housing with a front face to which a control element is fitted, an attachment face on which an attachment apparatus for snapping the device onto busbars of an installation distribution block is fitted, broad faces which connect the front face and the attachment face, and narrow faces which likewise run between the front face and the attachment face. A current path runs within the housing between connecting terminals which are accessible from the narrow faces for connection of connecting conductors which current path can be interrupted and closed again at least one main contact point by a switching apparatus. In addition, the device also has tripping elements, such as thermal overcurrent releases or magnetic quick-action releases, which respond to faulty operating states of the downstream current lines, for example when a thermal overcurrent is present for a relatively long time or a short-circuit current is present, and then by interaction with the switching apparatus, interrupt the current flow through the current path. The switch apparatus normally has a contact lever, which is mounted such that it can pivot and has a moving contact piece and a stationary contact piece, which interact in order to form a contact point which can be opened.

When the contact point opens, in particular when switching a short-circuit current, a switching arc is struck between the two contact pieces after they have been disconnected, and is introduced into an arc quenching apparatus, in order to speed up its quenching by means of arc guide rails. When the switching arc is struck, switching gases are formed as well as a pressure wave. The switching gases and the pressure wave escape from the device via non-sealed points or deliberately introduced openings in the housing, in particular on the attachment face. When the switching gases precipitate outside the housing on the busbars or on adjacent devices, then this can lead to adverse effects there.

DE 103 35 496 A1 discloses a part, in particular an installation switching device, which can be arranged on mount elements, in particular busbars, of an electrical device, in particular of a distribution block, having at least one first attachment element, which grips behind one of the busbars, and a second attachment element. The second attachment element is fitted to the narrow face of the installation switching device which is at the top in the installation position and has at least one hook by means of which it grips over one of the busbars from above. The second attachment part is disclosed as a lug, without any further functionality.

DE 195 13 062 C2 discloses an installation switching device, in which an attachment element which grips under the busbar is provided on the upper face and furthermore makes electrical contact with the busbar (neutral-conductor contact). The attachment element has no further functionality.

### SUMMARY OF THE INVENTION

An aspect of the present invention is to provide an installation switching device having an apparatus for mounting on a busbar, in which the switching gases are guided in a controlled manner such that there is no adverse effect on the environment of the switching device.

In an embodiment, an installation switching device according to the invention therefore has a vent channel through which the switching gases can escape from the housing interior and whose outlet opening is located close to the connecting terminal on the housing narrow face, and also an attachment element for attachment of the installation switching device to a busbar, which is fitted to the narrow face of the installation device housing and has an exhaust-gas channel whose inlet opening corresponds with the outlet opening of the vent channel, such that the switching gases which emerge from the outlet opening are passed on through the exhaust-gas channel of the attachment element.

The advantage of the invention is that one attachment element can provide a plurality of functions thus overall allowing a more compact, and therefore simpler, design and simpler handling of the installation switching device, in particular when mounted in a distribution box. The switching gases which are created in the interior of the installation switching device when a short circuit is interrupted are dissipated from the installation switching device in an area outside it and in which area they cannot cause any damage. At the same time, the connecting terminals can be accessed without any impediment through the attachment apparatus, in order to introduce a connecting conductor there.

According to one advantageous embodiment of the invention, the attachment element comprises a base body which is fitted on a narrow face of the installation switching device, which is located at the top when the installation switching device is in the installed position, and which has a mounting face which is matched to the narrow face of the installation switching device which is located at the top in the installed position, and by means of which the attachment element rests on the narrow face. This ensures that there is a sealed connection between the attachment element and the narrow face of the housing, and that the switching gases cannot escape outside the exhaust gas channel.

According to one advantageous embodiment of the invention, a latching hook is integrally formed on the attachment element, which latching hook points away from the attachment plane of the installation switching device approximately at right angles to this plane, and which latching hook is fitted with at least one flexible latching tab which can grip a busbar from above when the installation switching device is in the installed position.

In this case, the attachment element together with the latching hook and the latching tab may be composed of an electrically insulating, elastic material, for example Thermolast.

With regard to the attachment of the attachment element to the housing of the installation switching device, one advantageous embodiment of the invention proposes that the attachment element be latched onto the narrow face of the installation switching device. A further, highly advantageous embodiment relating to this proposes that the attachment element be attached to the narrow face of the installation switching device by a riveted joint.

With regard to the position of the exhaust gas channel in the attachment element, one advantageous embodiment of the invention proposes that the exhaust gas channel run in the base body of the attachment element from the mounting face to an upper face of the attachment element which is opposite the mounting face, such that the switching gases which emerge from the outlet opening are passed upward out of the area of the busbars when the installation switching device is installed in an installation distribution block.

A further, advantageous embodiment of the invention in this context proposes that the exhaust gas channel run in the base body of the attachment element from the mounting face to an attachment face, which is adjacent to the mounting face, of the attachment element, such that the switching gases which emerge from the outlet opening are passed out of the area of the busbars at the side in the direction of the attachment face, when the installation switching device is installed in an installation distribution block. The outlet point for the switching gases created in this way is in this case located above the busbars, as a result of which the switching gases do not touch the busbars.

In order nevertheless to allow a connecting conductor to be introduced into the connecting terminal despite the attachment element being fitted onto the narrow face in the vicinity of the connecting terminal, one particularly advantageous embodiment of the invention furthermore provides that the attachment element be fitted with an entry channel for a connecting conductor to pass through, which entry channel corresponds with the outgoer terminal opening of the installation switching device and is open on the mounting face and the upper face.

According to one advantageous embodiment of the invention, the installation switching device is provided in a three-pole version, with a common housing and a common attachment element with a latching hook, three exhaust gas channels and three entry channels being provided for three poles which are located alongside one another. According to a further advantageous embodiment of the invention, an installation switching device according to the invention can also be designed in a single-pole version, with a dedicated attachment element with a latching hook, an exhaust gas channel and an entry channel being provided for each pole.

### BRIEF DESCRIPTION OF THE DRAWINGS

The invention as well as further advantageous refinements and improvements of the invention will be explained and described in more detail with reference to the drawings, which illustrate one exemplary embodiment of the invention, and in which:

FIG. 1 shows a view of the broad face of an installation switching device according to the invention,

FIG. 2 shows a view of the narrow face of a three-pole installation switching device according to the invention, and

FIG. 3 shows a view of the front face of an installation switching device according to the invention.

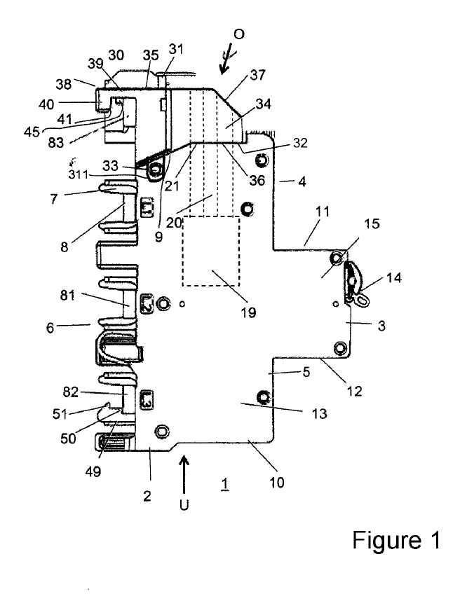

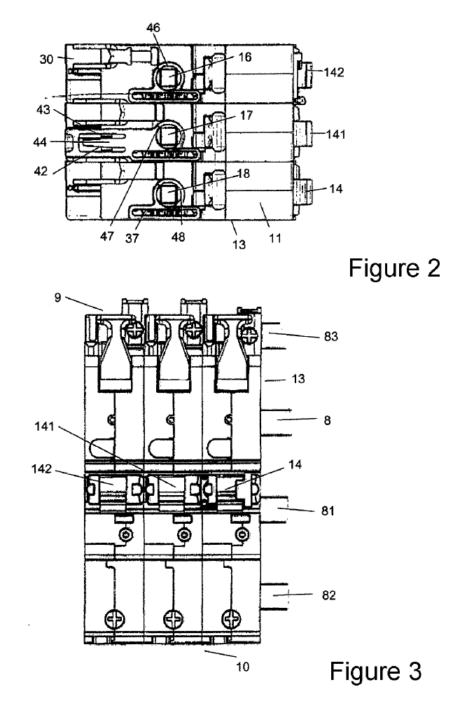

FIGS. 1 to 3 show various views of an installation switching device according to the invention. FIG. 1 shows a view of the broad face, FIG. 2 shows a view from above, and

FIG. 3 shows a view of the front face.

### DETAILED DESCRIPTION

FIG. 1 will be considered first of all. This shows an installation switching device 1, in this case a main line circuit breaker. The main line circuit breaker shown here has three switch poles in one housing. It has an insulating material housing 2 which is assembled from two half shells. The housing is approximately in the form of a T on its side. It comprises a front front face 3, rear front faces 4 and 5, and an attachment face 6, which is opposite the front faces. A terminal contact 7 is provided for each pole on the attachment face 6, by means of which the installation switching device 1 is held on a respective conductor rail 8, 81, 82 also referred to as busbars, of an installation distribution block. The illustration in FIG. 1 shows the installation switching device in its installed position. The narrow face 9 of the housing, which is annoted with the arrow O, is in this case referred to as the upper, rear narrow face, and the narrow face 10, which is annoted with the arrow U, is in this case referred to as the lower, rear narrow face. An upper, front narrow face 11 and a lower, front narrow face 12 are also located between the front front face 3 and the rear front faces 4, 5. The narrow faces 9, 11, 12, 10 are connected to the front faces 4, 3, 5 and to the attachment face 6 via broad faces 13.

A switching toggle 14 is fitted to the front front face 3, by means of which a latching mechanism, which is accommodated in the interior of the housing 2, in the area of the longitudinal web 15 of the T-shape, can be switched on and off manually.

Connecting terminals for connection of connecting conductors which are accessible through corresponding connecting terminal openings 16, 17, 18 through the housing wall are accommodated on the upper and lower narrow faces 9, 10 of the housing. These can be seen in FIG. 2, in which each of the connecting terminal openings 16, 17, 18 is associated with one switch pole of the device. The terminals and terminal openings on the lower narrow face 10 of the housing are not illustrated here. The terminals on the upper narrow face are spring-loaded terminals in which the connecting conductor can be clamped firmly without any screws.

Dashed lines in the interior of the housing schematically illustrate an arc quenching arrangement 19 and a vent channel 20 which leads from the arc quenching arrangement 19 to the upper narrow face 9 of the housing and through which switching gases and any overpressure which is created during switching can escape from the housing on the upper, rear narrow face 9 through outlet openings 21.

An attachment element 30 is fitted and attached to the upper, rear narrow face 9 of the housing 2 and has a base body 31 which is approximately in the form of a box and whose one longitudinal face is in the form of a mounting face 32, whose contour is matched to the contour of the upper, rear narrow face 9, such that the base body 31 can be fitted with an accurate fit to the upper rear narrow face. On the mounting face 32, the base body has a lug-like projection 311 by means of which it engages in the form of a pocket on the upper rear narrow face 9 during fitting, and is fixed there by a riveted joint 33.

Exhaust gas channels 34 run in the interior of the base body 31, between the mounting face 32 and the opposite narrow face 35. The inlet openings 36 of the exhaust gas channels are located on the outlet openings 21 of the vent channels 20. After emerging from the outlet openings 21, the switching gases are passed further upwards through them to the outlet openings 37 of the exhaust gas channels 34, where they emerge into the environment. The outlet of the outlet openings 37 is located so far away from the busbars 8, 81, 82, 83 that there is no risk of the busbars being adversely affected by the emerging switching gases.

A latching hook 38 is integrally formed on the base body 31 and its elongated limb 39 projects approximately at right angles to the mounting face 6 in an extension of the narrow face 35 of the attachment element 30, with a latching tab 40 being located at its free end. The distance between the inner edge 41 of the latching tab 40 and the broad face 6 is of such a size that a double-thickness busbar can be surrounded by the latching tab 40 clamping it. A deformable tongue 44 is formed on the upper face of the elongated limb 39 by means of two cutouts 42, 43, which are in the form of slots and run parallel to one another, see FIG. 2, at the free end of which tongue 44 a further, inner latching tab 45 is fitted. The distance between the inner latching tab 45 and the attachment face 6 is of such a magnitude that a single-thickness busbar 83 can be surrounded by the inner latching tab clamping it. This arrangement of two latching tabs which are offset with respect to one another allows the latching hook 38 to be latched to busbars of both single and double thickness.

Furthermore, entry channels 46, 47, 48 run through the base body 31 in order to pass a connecting conductor through to the respective connecting terminal openings 16, 17, 18. In this case, the entry channels 46, 47, 48 are located precisely above the connecting terminal openings 16, 17, 18 associated with them.

In the installation switching device illustrated in the figures, the attachment element 30 has a latching hook which is common to all three poles but has an entry channel and an exhaust gas channel for each switch pole, and a switching toggle 14, 141, 142 for each switch pole.

A further latching apparatus 49 is fitted on the attachment face 6 in the vicinity of the lower narrow face 10 and likewise comprises a latching hook with two latching tabs 50, 51 at a distance from one another. The latching tabs 50, 51 are fitted such that they surround a busbar 82 from underneath, in a latching manner, to be precise either a single-thickness busbar with the latching tab 50 or a double-thickness busbar with the latching tab 51.

In the illustrated example, the installation switching device is mounted on a total of four busbars, of which the uppermost busbar 83 is the neutral conductor, and the other three busbars 8, 81, 82 correspond to the phases L1, L2, L3.

In a modification of the profile of the exhaust gas channels 34 in the base body 31 as illustrated in FIG. 1, these exhaust gas channels 34 can also run in such a way that they open on the upper broad face in the vicinity of the latching hook 38. The switching gases are then dissipated in the direction of the broad face toward the neutral conductor. This is electrically unproblematic, since the neutral conductor 83 does not carry any current. This variant for carrying gas through exhaust gas channels in the base body 31 is advantageous when further installation switching devices are fitted on a second plane within the distribution box above the installation switching device, thus preventing the switching gases from blowing on these other devices, or when there is a risk of deposits or dirt being able to fall from above into the output openings 37 of the exhaust gas channels 34, and blocking them.

### LIST OF REFERENCE SYMBOLS

1 Installation switching device
2 Insulating material housing
3 Front front face
4 Rear front face
5 Rear front face
6 Attachment face
7 Terminal contact
8 Conductor rail, busbar
81 Conductor rail, busbar
82 Conductor rail, busbar
83 Conductor rail, busbar
9 Narrow face, top
10 Narrow face, bottom
11 Front, upper narrow face
12 Front, lower narrow face
13 Broad face
14 Switching toggle
141 Switching toggle
142 Switching toggle
15 Longitudinal web of the T shape
16 Connecting terminal opening
17 Connecting terminal opening
18 Connecting terminal opening
19 Arc quenching arrangement
20 Vent channel
21 Outlet openings
30 Attachment element
31 Base body
311 Lug-like projection
32 Mounting face
33 Riveted joint
34 Exhaust gas channel
35 opposite narrow face
36 Inlet openings
37 Outlet openings
38 Latching hook
39 Elongated limb
40 Latching tab
41 Inner face
42 Cutout in the form of a slot
43 Cutout in the form of a slot
44 Tongue
45 Inner latching tab
46 Entry channel
47 Entry channel
48 Entry channel
49 Further latching apparatus
51 Further latching tab
51 Further latching tab

1-11. (canceled)

12. An installation switching device comprising:
an installation device housing including a housing interior;
a connecting terminal disposed on a narrow face of the installation device housing;
a switching apparatus including a quenching chamber;
a vent channel configured to allow switching gases from a switching operation to escape from the housing interior through an outlet opening disposed close to the connecting terminal; and
an attachment element disposed on the narrow face and including an exhaust-gas channel having an inlet opening corresponding with the outlet opening of the vent channel so as to allow the switching gases to pass from the outlet opening of the vent channel through the exhaust-gas channel, the attachment element configured to attach the installation switching device to a busbar.

13. The installation switching device as recited in claim 12, wherein the attachment element includes a base body disposed on the narrow face at a top portion of the installation switching device housing in an installed position, the base body having a mounting face corresponding to the narrow face, wherein the attachment element is disposed on the narrow face via the base body.

14. The installation switching device as recited in claim 13, wherein the attachment element includes a latching hook configured to point away from an attachment plane of the installation switching device housing at a right angle to the attachment plane, and wherein the latching hook includes at least one flexible latching tab configured to grip a busbar when the installation switching device is in an installed position.

15. The installation switching device as recited in claim 14, wherein the attachment element, the latching hook and the at least one flexible latching tab include an electrically insulating, elastic material.

16. The installation switching device as recited in claim 15, wherein the electrically insulating, elastic material includes Thermolast®.

17. The installation switching device as recited in claim 12, wherein the attachment element is latched on the narrow face.

18. The installation switching device as recited in claim 12, further comprising a riveted joint configured to attach the attachment element to the narrow face of the installation switching device.

19. The installation switching device as recited in claim 13, wherein the exhaust gas channel is disposed between the mounting face and an upper face of the attachment element opposite the mounting face so as to allow the switching gases emerging from an outlet opening of the exhaust gas channel to pass upward out of an area of the busbar when the installation switching device is installed in an installation distribution block.

20. The installation switching device as recited in claim 13, wherein the exhaust gas channel is disposed between the mounting face and an attachment face of the attachment element adjacent to the mounting face so as to allow the switching gases emerging from an outlet opening of the exhaust gas channel to pass out of an area of the busbar in a direction of the attachment face when the installation switching device is installed in an installation distribution block.

21. The installation switching device as recited in claim 12, wherein the attachment element includes an entry channel corresponding with an outgoer terminal opening of the installation switching device open on the mounting face and the narrow face.

22. The installation switching device as recited in claim 12, wherein the installation switching device is a three-pole version including a common attachment element with a latching hook, and further comprising second and third exhaust-gas channels and second and third entry channels, each assigned to one of three poles.

23. The installation switching device as recited in claim 22, wherein the installation switching device is a single pole version including a dedicated attachment element with a latching hook, wherein the exhaust-gas channel and the entry channel are assigned to the single pole.
